(19) United States
(12) Patent Application Publication
(10) Pub. No.: US 2026/0358865 A1
(43) Pub. Date: Nov. 12, 2026

(54) CHASSIS AND HOST COMPUTER

(71) Applicant: COOLER MASTER TECHNOLOGY INC., Taipei City (TW)

(72) Inventors: Minhua ZHANG, Taipei City (TW); Yu-Qing LYU, Hui Zhou City (CN)

(73) Assignee: COOLER MASTER TECHNOLOGY INC., Taipei City (TW)

(21) Appl. No.: 19/245,067

(22) Filed: Jun. 20, 2025

(30) Foreign Application Priority Data
May 12, 2025 (CN) 202510603173.0

(51) Int. Cl. G06F 1/18

(52) U.S. Cl. CPC G06F 1/181

(57) ABSTRACT

A host computer includes a chassis, a motherboard, a power supply and an expansion card. The chassis includes a frame, a bottom plate, a top plate and a back plate. The bottom plate, the top plate and the back plate are disposed on the frame. The back plate includes a motherboard bracket, a power supply bracket and an expansion card bracket. The power supply bracket and the expansion card bracket are disposed on the frame. The motherboard is connected to the motherboard bracket. The power supply is connected to the power supply bracket. The expansion card is connected to the expansion card bracket. The power supply bracket and the expansion card bracket are arranged longitudinally to form a first accommodating space, or are arranged transversely to form a second accommodating space. The first accommodating space or the second accommodating space is to allow the motherboard to be disposed therein.

### CROSS-REFERENCE TO RELATED APPLICATIONS

This non-provisional application claims priority under 35 U.S.C. § 119(a) on Patent Application No(s). 202510603173.0 filed in China, on May 12th, 2025 , the entire contents of which are hereby incorporated by reference.

### TECHNICAL FIELD

The present disclosure relates to a chassis and a host computer, more particularly to a chassis and a host computer having a power supply bracket and an expansion card bracket arranged longitudinally or transversely.

### BACKGROUND

With rapid development of information technology, the advancement of computers has significantly enhanced the convenience of modern daily life. In everyday activities, computer products or apparatuses that are applied to computers are usually relied upon to perform various operations.

A conventional host computer mainly includes a chassis and a motherboard installed within the chassis. Generally, the motherboard of an appropriate size may be adopted according to requirements, and then a chassis supporting the aforementioned motherboard may be further chosen. However, when the motherboard of a different size needs to be replaced due to specific requirements, the replacement motherboard may be incompatible with the existing chassis. Accordingly, the chassis must also be replaced, which causes the inconvenience during assembly and increases the cost of assembling the host computer. Therefore, improving the convenience of motherboard assembly to reduce the overall assembly cost of the host computer is one of the problems that needs to be addressed.

### SUMMARY

The present disclosure provides a chassis and a host computer so as to improve the convenience of motherboard assembly, thereby reducing the cost of assembling the host computer.

One embodiment of the present disclosure provides a chassis including a frame, a bottom plate, a top plate and a back plate. The bottom plate is disposed on the frame. The top plate is disposed on the frame. The top plate and the bottom plate are opposite to each other. The back plate is disposed on the frame. The back plate is located between the bottom plate and the top plate. The back plate includes a motherboard bracket, a power supply bracket and an expansion card bracket. The power supply bracket and the expansion card bracket are detachably disposed on the frame. The power supply bracket and the expansion card bracket are arranged longitudinally or transversely between the bottom plate and the motherboard bracket.

Another embodiment of the present disclosure provides a host computer including a chassis, a motherboard, a power supply and at least one expansion card. The chassis includes a frame, a bottom plate, a top plate and a back plate. The bottom plate is disposed on the frame. The top plate is disposed on the frame. The top plate and the bottom plate are opposite to each other. The back plate is disposed on the frame. The back plate is located between the bottom plate and the top plate. The back plate includes a motherboard bracket, a power supply bracket and an expansion card bracket. The power supply bracket and the expansion card bracket are detachably disposed on the frame. The motherboard is connected to the motherboard bracket. The power supply is connected to the power supply bracket. The power supply is electrically connected to the motherboard. The at least one expansion card is connected to the expansion card bracket. The at least one expansion card is electrically connected to the motherboard. The power supply bracket and the expansion card bracket are arranged longitudinally between the bottom plate and the motherboard bracket to form a first accommodating space between the power supply and the top plate, or the power supply bracket and the expansion card bracket are arranged transversely between the bottom plate and the motherboard bracket to form a second accommodating space between at least a portion of the bottom plate and the top plate. A size of the second accommodating space is greater than a size of the first accommodating space. The first accommodating space or the second accommodating space is configured to allow the motherboard to be disposed therein.

According to the chassis and the host computer as described in the above embodiments, the back plate includes the motherboard bracket, the power supply bracket and the expansion card bracket, and the power supply bracket and the expansion card bracket can be arranged longitudinally or transversely between the bottom plate and the motherboard bracket. Therefore, when a user intends to replace the motherboard with one of a larger size, the installation space within the chassis for the motherboard can be enlarged by changing the arrangement direction of the power supply bracket and the expansion card bracket without replacing the chassis. That is, the chassis of this embodiment can accommodate motherboards of different sizes by adjusting the arrangement of the power supply bracket and the expansion card bracket. Accordingly, the convenience of motherboard assembly can be improved, thereby reducing the overall assembly cost of the host computer.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a perspective view of a host computer in accordance with an embodiment of the present disclosure, in which a power supply bracket and an expansion card bracket are arranged longitudinally and no expansion card is installed;

FIG. 2 is another perspective view of the host computer in FIG. 1;

FIG. 3 is a side view of the host computer in FIG. 1, with the expansion card installed;

FIG. 4 is another side view of the host computer in FIG. 1, with the expansion card installed;

FIG. 5 is an exploded view of a back plate of the host computer in FIG. 1;

FIG. 6 is a perspective view of the host computer in FIG. 1, in which the power supply bracket and the expansion card bracket are rearranged transversely and no expansion card is installed;

FIG. 7 is another perspective view of the host computer in FIG. 6;

FIG. 8 is a side view of the host computer in FIG. 6, with the expansion card installed;

FIG. 9 is another side view of the host computer in FIG. 6, with the expansion card installed; and

FIG. 10 is an exploded view of the back plate of the host computer in FIG. 6.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

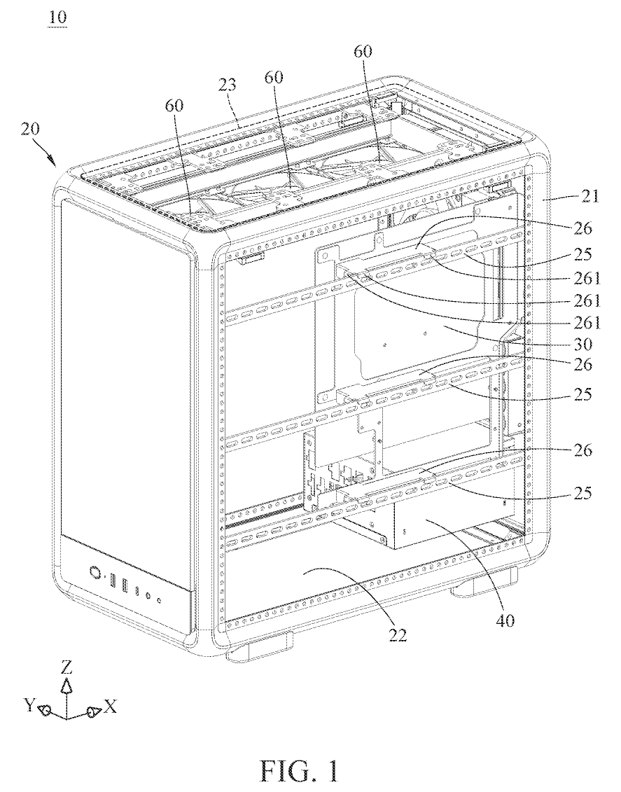

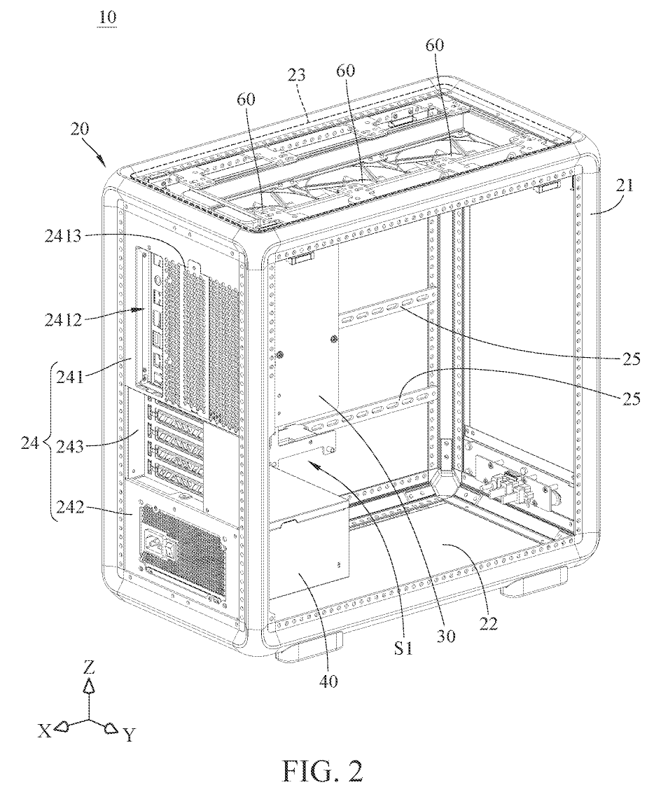

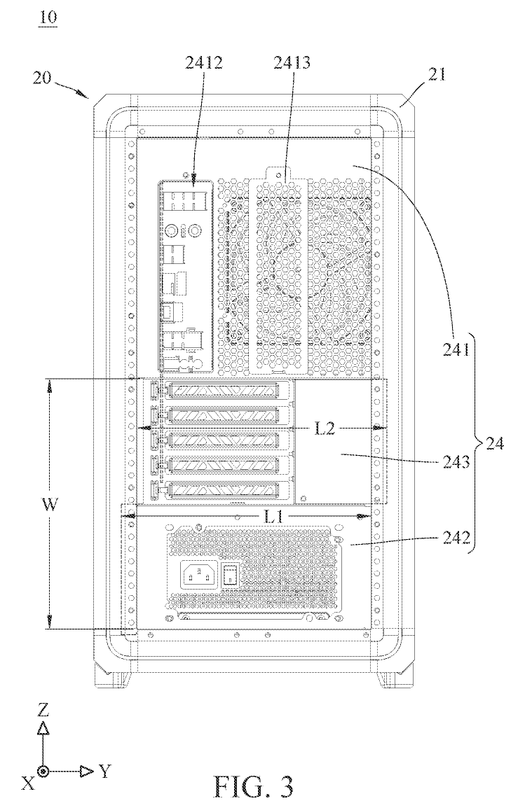

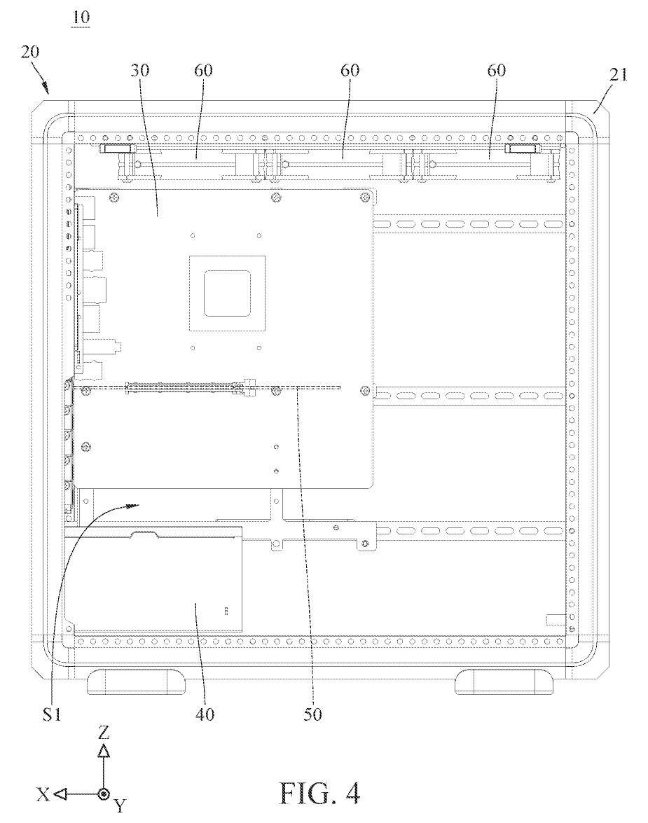

Please refer to FIGS. 1-4, where FIG. 1 is a perspective view of a host computer 10 in accordance with an embodiment of the present disclosure, in which a power supply bracket 242 and an expansion card bracket 243 are arranged longitudinally and no expansion card 50 is installed, FIG. 2 is another perspective view of the host computer 10 in FIG. 1, FIG. 3 is a side view of the host computer 10 in FIG. 1, with the expansion card 50 installed, and FIG. 4 is another side view of the host computer 10 in FIG. 1, with the expansion card 50 installed.

In this embodiment, the host computer 10 includes a chassis 20, a motherboard 30, a power supply 40 and an expansion card 50. The chassis 20 includes a frame 21, a bottom plate 22, a top plate 23 and a back plate 24. The bottom plate 22 is disposed on the frame 21. The top plate 23 is disposed on the frame 21. The top plate 23 and the bottom plate 22 are opposite to each other. The back plate 24 is disposed on the frame 21, and is located between the bottom plate 22 and the top plate 23.

The back plate 24 includes a motherboard bracket 241, a power supply bracket 242 and an expansion card bracket 243. The power supply bracket 242 and the expansion card bracket 243 are detachably disposed on the frame 21. The power supply bracket 242 and the expansion card bracket 243 are arranged longitudinally between the bottom plate 22 and the motherboard bracket 241. A length L1 of the power supply bracket 242 and a length L2 of the expansion card bracket 243 are, for example, equal to a total width W of the power supply bracket 242 and the expansion card bracket 243. That is, one side of the power supply bracket 242 and the expansion card bracket 243, for example, forms a square shape. Alternatively, the power supply bracket 242 and the expansion card bracket 243 may be adjusted, for example, to be offset from each other by a certain distance according to an internal arrangement of the chassis 20.

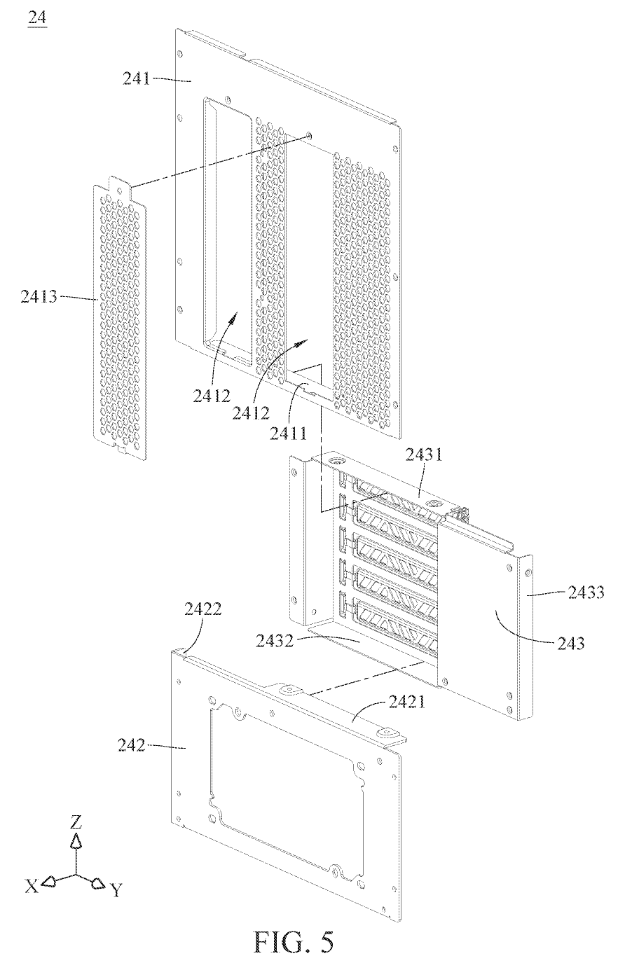

Please refer to FIGS. 1-5, where FIG. 5 is an exploded view of the back plate 24 of the host computer 10 in FIG. 1. The motherboard bracket 241 has a first joining portion 2411. The power supply bracket 242 has a second joining portion 2421. Two opposite sides of the expansion card bracket 243 have a third joining portion 2431 and a fourth joining portion 2432, respectively.

When the power supply bracket 242 and the expansion card bracket 243 are arranged longitudinally, the first joining portion 2411 is detachably connected to the third joining portion 2431, and the second joining portion 2421 is detachably connected to the fourth joining portion 2432. For example, the first joining portion 2411 is connected to the third joining portion 2431 via engagement and physical contact, and the second joining portion 2421 is connected to the fourth joining portion 2432 via engagement and physical contact.

The motherboard 30 is connected to the motherboard bracket 241 via, for example, screwing. The specification of the motherboard 30 is, for example, micro-ATX. The power supply 40 is connected to the power supply bracket 242, and is electrically connected to the motherboard 30. The expansion card 50 is connected to the expansion card bracket 243, and is electrically connected to the motherboard 30. The expansion card 50 is, for example, a PCIe card. When the power supply bracket 242 and the expansion card bracket 243 are arranged longitudinally between the bottom plate 22 and the motherboard bracket 241, a first accommodating space S1 is formed between the power supply 40 and the top plate 23. The first accommodating space S1 is configured to allow the motherboard 30 to be disposed therein. The aforementioned “arranged longitudinally” refers to an arrangement direction parallel to an extension direction of the Z-axis as shown in FIGS. 1-4.

In this embodiment, when the power supply bracket 242 and the expansion card bracket 243 are arranged longitudinally between the bottom plate 22 and the motherboard bracket 241, built-in fans (not shown) of the power supply 40, for example, correspond to an air outlet (not shown) of the bottom plate 22. That is, an exhaust direction of the built-in fan of the power supply 40 is, for example, oriented downward, but the present disclosure is not limited thereto. In other embodiments, the exhaust direction of the built-in fan of the power supply may be, for example, oriented upward.

In this embodiment, the chassis 20 may include a plurality of mounting brackets 25 and a plurality of mounting components 26. The mounting brackets 25 are disposed on the frame 21, and are configured to allow the motherboard 30 to be detachably mounted thereon. The mounting components 26 are connected to the motherboard 30, and are detachably mounted to the mounting brackets 25, respectively. In detail, two different sides of each of the mounting components 26 each have a plurality of engagement structures 261. The engagement structures 261 located on a side of each of the mounting components 26 are configured to engage with one of the mounting brackets 25 to assemble the mounting components 26 on the mounting brackets 25, respectively.

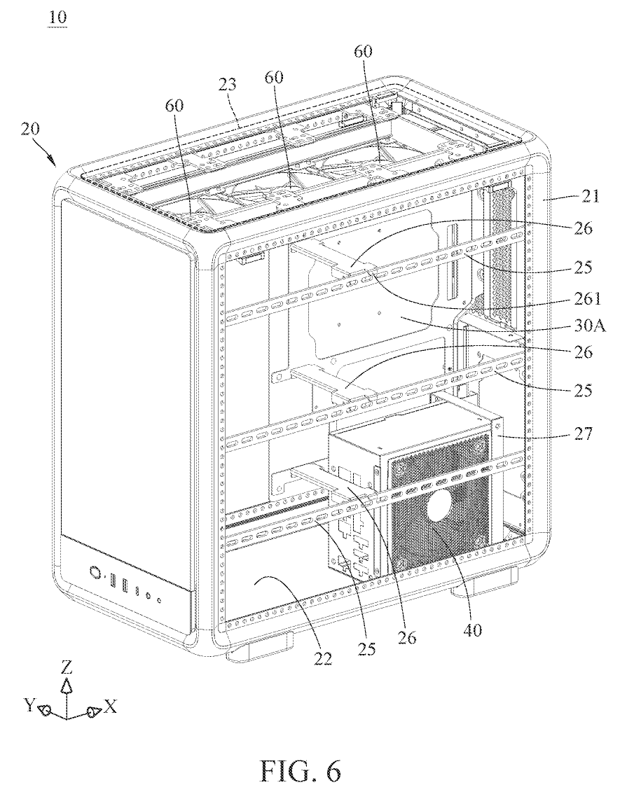

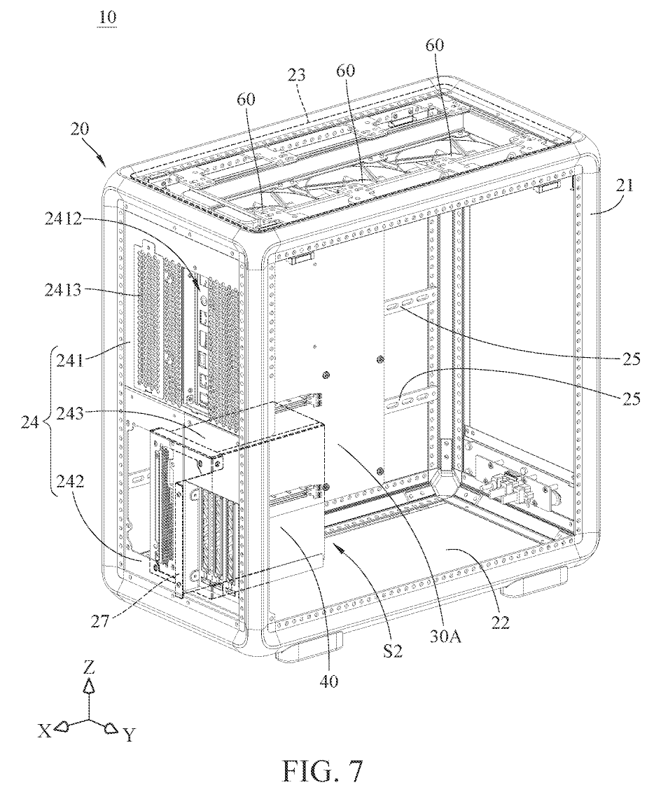

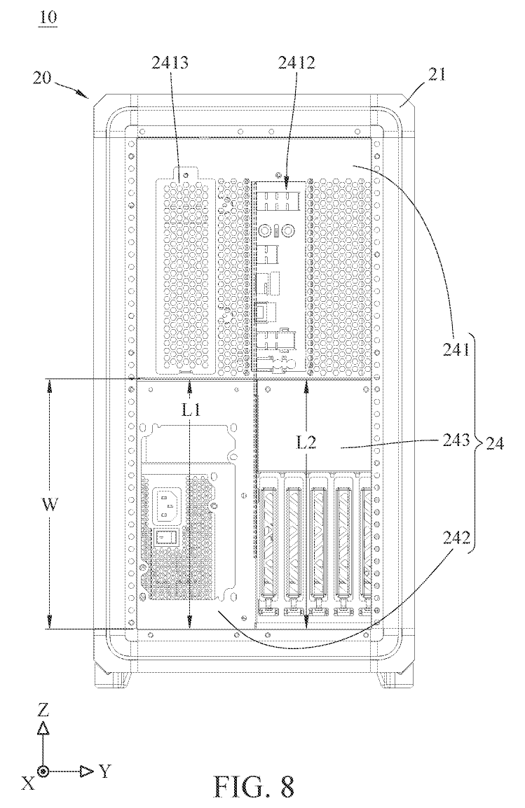

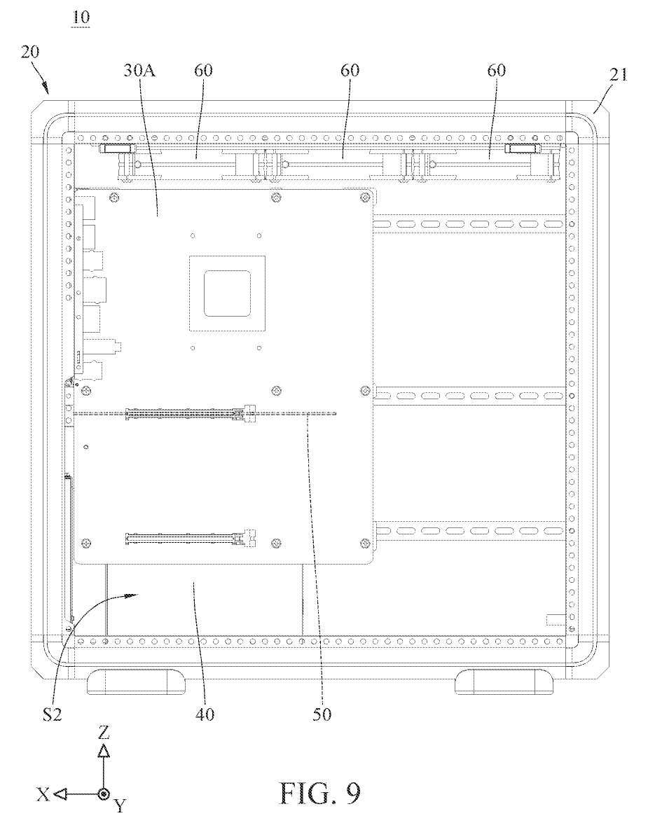

Please refer to FIGS. 1-9, where FIG. 6 is a perspective view of the host computer 10 in FIG. 1, in which the power supply bracket 242 and the expansion card bracket 243 are rearranged transversely and no expansion card 50 is installed, FIG. 7 is another perspective view of the host computer 10 in FIG. 6, FIG. 8 is a side view of the host computer 10 in FIG. 6, with the expansion card 50 installed, and FIG. 9 is another side view of the host computer 10 in FIG. 6, with the expansion card 50 installed.

In this embodiment, when a user intends to install the motherboard 30A of, for example, the ATX specification in the chassis 20, the power supply bracket 242 and the expansion card bracket 243 may be rearranged to be transversely aligned between the bottom plate 22 and the motherboard bracket 241. A second accommodating space S2 is formed between at least a portion of the bottom plate 22 and the top plate 23. A size of the second accommodating space S2 is greater than a size of the first accommodating space S1, and a size of the motherboard 30A of the ATX specification is greater than a size of the motherboard 30 of the micro-ATX specification. The second accommodating space S2 is configured for the motherboard 30A to be disposed. Accordingly, in this embodiment, by changing the arrangement direction of the power supply bracket 242 and the expansion card bracket 243, the power supply 40 and the expansion card 50 are reoriented together, thereby making space available for installing the motherboard 30A of larger size.

The aforementioned “arranged transversely” refers to an arrangement direction parallel to an extension direction of the Y-axis as shown in FIGS. 6-9. That is, the arrangement direction of the power supply bracket 242 and the expansion card bracket 243 as shown in FIGS. 6-9 is obtained by rotating the arrangement direction shown in FIGS. 1-4 by 90 degrees. Since the one side of the power supply bracket 242 and the expansion card bracket 243 forms a square shape, the power supply bracket 242 and the expansion card bracket 243 can still be fitted to the frame 21 after the arrangement direction of the power supply bracket 242 and the expansion card bracket 243 is rotated by 90 degrees.

In this embodiment, the installation position of the motherboard 30A of the ATX specification is, for example, shifted 74 millimeters from the installation position of the motherboard 30 of the micro-ATX specification. In detail, the installation position of the motherboard 30A of the ATX specification is shifted along the Y-axis as shown in FIGS. 6-10 toward a direction away from the power supply 40. In addition, the expansion card 50 is electrically connected to the motherboard 30A via, for example, an adapter.

In this embodiment, the chassis 20 may further include a connecting bracket 27. When the user intends to install the motherboard 30A of the ATX specification in the chassis 20 via the aforementioned modification of the power supply bracket 242 and the expansion card bracket 243, the connecting bracket 27 connects the bottom plate 22 and the power supply bracket 242, and the power supply 40 is mounted on the connecting bracket 27. Accordingly, the power supply 40 can be repositioned to accommodate structural adjustments of other components within the chassis 20 during assembly, such that the power supply 40 can be prevented from interfering other components within the chassis 20.

In this embodiment, the installation direction of the mounting components 26 changes with the rotation of the arrangement direction of the power supply bracket 242 and the expansion card bracket 243. That is, each of the mounting components 26 is changed to be engaged with the mounting brackets 25 via the engagement structures 261 located on another side thereof. In addition, the installation direction of the built-in fans of the power supply 40 also changes with the rotation of the arrangement direction of the power supply bracket 242 and the expansion card bracket 243. For example, the installation direction of the built-in fans of the power supply 40 is changed to face away from the motherboard 30A.

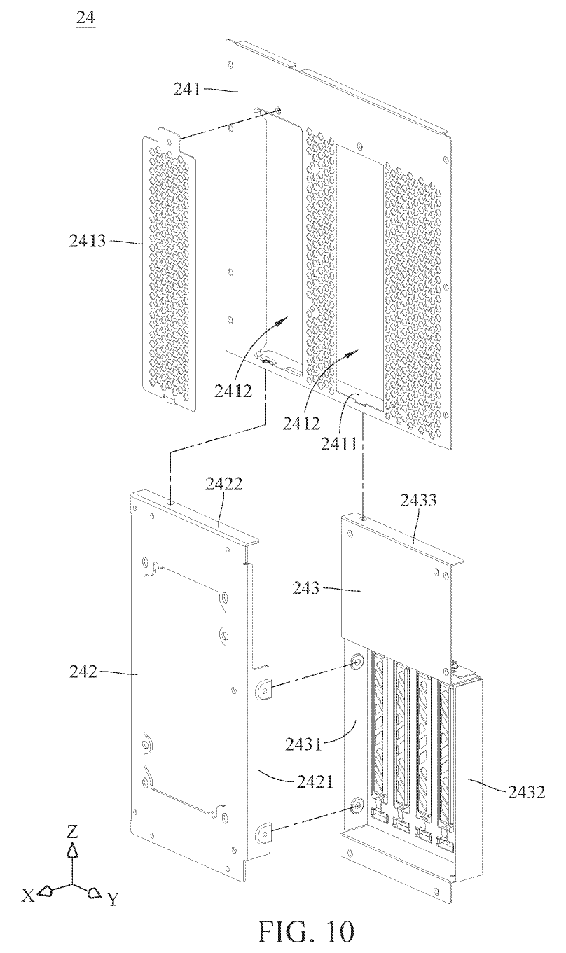

Please refer to FIGS. 1-10, where FIG. 10 is an exploded view of the back plate 24 of the host computer 10 in FIG. 6. The detail modifications of the power supply bracket 242 and the expansion card bracket 243 will be described below. In this embodiment, the power supply bracket 242 further has a fifth joining portion 2422. The fifth joining portion 2422 is adjacent to the second joining portion 2421, and an extension direction of the fifth joining portion 2422 is, for example, perpendicular to an extension direction of the second joining portion 2421. The expansion card bracket 243 further has a sixth joining portion 2433. Two opposite sides of the sixth joining portion 2433 are adjacent to the third joining portion 2431 and the fourth joining portion 2432, respectively, and an extension direction of the sixth joining portion 2433 is, for example, perpendicular to an extension direction of the third joining portion 2431 and the fourth joining portion 2432.

When the power supply bracket 242 and the expansion card bracket 243 are arranged longitudinally, the fifth joining portion 2422 and the sixth joining portion 2433 are spaced apart from each other and are not positioned side by side. When the power supply bracket 242 and the expansion card bracket 243 are rearranged to be transversely aligned, the fifth joining portion 2422 and the sixth joining portion 2433 are arranged side by side. The first joining portion 2411 is detachably connected to the fifth joining portion 2422 and the sixth joining portion 2433, and the second joining portion 2421 is detachably connected to the third joining portion 2431. For example, the first joining portion 2411 is connected to the fifth joining portion 2422 and the sixth joining portion 2433 via screw fastening, and the second joining portion 2421 is connected to the third joining portion 2431 via screw fastening.

In this embodiment, the back plate 24 includes the motherboard bracket 241, the power supply bracket 242 and the expansion card bracket 243, and the power supply bracket 242 and the expansion card bracket 243 can be arranged longitudinally or transversely between the bottom plate 22 and the motherboard bracket 241. Therefore, when a user intends to replace the motherboard 30A with one of a larger size, the installation space within the chassis 20 for the motherboard 30A can be enlarged by changing the arrangement direction of the power supply bracket 242 and the expansion card bracket 243 without replacing the chassis 20. That is, the chassis 20 of this embodiment can accommodate motherboards 30 and 30A of different sizes by adjusting the arrangement of the power supply bracket 242 and the expansion card bracket 243. Accordingly, the convenience of motherboard assembly can be improved, thereby reducing the overall assembly cost of the host computer 10.

In this embodiment, the host computer 10 may further include a plurality of fans 60. The fans 60 are disposed on the frame 21, and are located on, for example, the top plate 23. The fans 60 are configured to generate a cooling airflow. Accordingly, electronic components disposed in the chassis 20 can be cooled via the cooling airflow generated by the fans 60.

In this embodiment, the motherboard bracket 241 may have two I/O openings 2412 and a cover 2413. An I/O port (not shown) of the motherboard 30 of the micro-ATX specification corresponds to one of the I/O openings 2412. An I/O port (not shown) of the motherboard 30A of the ATX specification corresponds to the other I/O opening 2412. The cover 2413 is configured to cover the unused I/O opening 2412 not corresponding to the I/O port of the motherboard 30 or 30A to serve as dust protection.

In this embodiment, the length L1 of the power supply bracket 242 and the length L2 of the expansion card bracket 243 are equal to the total width W of the power supply bracket 242 and the expansion card bracket 243. That is, one side of the power supply bracket 242 and the expansion card bracket 243 forms a square shape, but the present disclosure is not limited thereto. In other embodiments, the length of the power supply bracket and the length of the expansion card bracket may not be equal to the total width of the power supply bracket and the expansion card bracket. That is, a side of the power supply bracket and the expansion card bracket forms a rectangular shape, which is not matched to the frame completely. Portions of the host computer which are not covered by the power supply bracket and the expansion card bracket may be covered by, for example, additional plates, and portions of the power supply bracket and the expansion card bracket which extend beyond the frame may be, for example, folded and accommodated in the chassis.

In this embodiment, when the user intends to install the motherboard 30A of the ATX specification in the chassis 20 via the aforementioned modification of the power supply bracket 242 and the expansion card bracket 243, the power supply 40 is mounted on the connecting bracket 27, but the present disclosure is not limited thereto. In other embodiments, the chassis may not include a connecting bracket, and the power supply may be directly connected to the power supply bracket.

In this embodiment, there is one expansion card 50 merely, but the present disclosure is not limited thereto. In other embodiments, there may be multiple expansion cards.

In this embodiment, there are multiple mounting brackets 25 and multiple mounting components 26, but the present disclosure is not limited thereto. In other embodiments, there may be one mounting bracket and one mounting component merely.

In this embodiment, there is one engagement structure 261 of each of the mounting components 26 merely, but the present disclosure is not limited thereto. In other embodiments, there may be multiple engagement structures of each of the mounting components.

In this embodiment, there are multiple fans 60, but the present disclosure is not limited thereto. In other embodiments, there may be one fan merely.

According to the chassis and the host computer as described in the above embodiments, the back plate includes the motherboard bracket, the power supply bracket and the expansion card bracket, and the power supply bracket and the expansion card bracket can be arranged longitudinally or transversely between the bottom plate and the motherboard bracket. Therefore, when the user intends to replace the motherboard with one of a larger size, the installation space within the chassis for the motherboard can be enlarged by changing the arrangement direction of the power supply bracket and the expansion card bracket without replacing the chassis. That is, the chassis of this embodiment can accommodate motherboards of different sizes by adjusting the arrangement of the power supply bracket and the expansion card bracket. Accordingly, the convenience of motherboard assembly can be improved, thereby reducing the overall assembly cost of the host computer.

It will be apparent to those skilled in the art that various modifications and variations can be made to the present disclosure. It is intended that the specification and examples be considered as exemplary embodiments only, with a scope of the present disclosure being indicated by the following claims.

What is claimed is:

1. A chassis, comprising:
a frame;
a bottom plate, disposed on the frame;
a top plate, disposed on the frame, wherein the top plate and the bottom plate are opposite to each other; and
a back plate, disposed on the frame, wherein the back plate is located between the bottom plate and the top plate, the back plate comprises a motherboard bracket, a power supply bracket and an expansion card bracket, and the power supply bracket and the expansion card bracket are detachably disposed on the frame;
wherein the power supply bracket and the expansion card bracket are arranged longitudinally or transversely between the bottom plate and the motherboard bracket.

2. The chassis according to claim 1, wherein a length of the power supply bracket and a length of the expansion card bracket are equal to a total width of the power supply bracket and the expansion card bracket.

3. The chassis according to claim 1, wherein the motherboard bracket has a first joining portion, the power supply bracket has a second joining portion, and two opposite sides of the expansion card bracket have a third joining portion and a fourth joining portion, respectively; when the power supply bracket and the expansion card bracket are arranged longitudinally, the first joining portion is detachably connected to the third joining portion, and the second joining portion is detachably connected to the fourth joining portion.

4. The chassis according to claim 3, wherein the power supply bracket further has a fifth joining portion adjacent to the second joining portion, the expansion card bracket further has a sixth joining portion, two opposite sides of the sixth joining portion are adjacent to the third joining portion and the fourth joining portion, respectively; when the power supply bracket and the expansion card bracket are arranged transversely, the fifth joining portion and the sixth joining portion are positioned side by side, the first joining portion is detachably connected to the fifth joining portion and the sixth joining portion, and the second joining portion is detachably connected to the third joining portion.

5. The chassis according to claim 4, wherein when the power supply bracket and the expansion card bracket are arranged longitudinally, the fifth joining portion and the sixth joining portion are spaced apart from each other and are not positioned side by side.

6. The chassis according to claim 1, further comprising at least one mounting bracket disposed on the frame, wherein the at least one mounting bracket is configured to allow a motherboard to be detachably mounted thereon.

7. The chassis according to claim 6, further comprising at least one mounting component configured to be connected to the motherboard, wherein the at least one mounting component is detachably mounted to the at least one mounting bracket.

8. The chassis according to claim 7, wherein the at least one mounting component has at least one engagement structure, and the at least one engagement structure is configured to engage with the at least one mounting bracket, thereby allowing the at least one mounting component to be mounted on the at least one mounting bracket.

9. A host computer, comprising:
a chassis, comprising:
a frame;
a bottom plate, disposed on the frame;
a top plate, disposed on the frame, wherein the top plate and the bottom plate are opposite to each other; and
a back plate, disposed on the frame, wherein the back plate is located between the bottom plate and the top plate, the back plate comprises a motherboard bracket, a power supply bracket and an expansion card bracket, and the power supply bracket and the expansion card bracket are detachably disposed on the frame;
a motherboard, connected to the motherboard bracket;
a power supply, connected to the power supply bracket, wherein the power supply is electrically connected to the motherboard; and
at least one expansion card, connected to the expansion card bracket, wherein the at least one expansion card is electrically connected to the motherboard;
wherein the power supply bracket and the expansion card bracket are arranged longitudinally between the bottom plate and the motherboard bracket to form a first accommodating space between the power supply and the top plate, or the power supply bracket and the expansion card bracket are arranged transversely between the bottom plate and the motherboard bracket to form a second accommodating space between at least a portion of the bottom plate and the top plate, a size of the second accommodating space is greater than a size of the first accommodating space, and the first accommodating space or the second accommodating space is configured to allow the motherboard to be disposed therein.

10. The host computer according to claim 9, wherein a length of the power supply bracket and a length of the expansion card bracket are equal to a total width of the power supply bracket and the expansion card bracket.
